(19) United States
(12) Patent Application Publication
(10) Pub. No.: US 2019/0095794 A1
(43) Pub. Date: Mar. 28, 2019

(54) METHODS AND APPARATUS FOR TRAINING A NEURAL NETWORK

(71) Applicant: Intel Corporation, Santa Clara, CA (US)

(72) Inventors: Rodrigo Aldana López, Zapopan (MX); Leobardo Emmanuel Campos Macías, Guadalajara (MX); Julio Cesar Zamora Esquivel, Zapopan (MX); Jesús Adán Cruz Vargas, Zapopan (MX); David Gómez Gutiérrez, Zapopan (MX)

(21) Appl. No.: 15/716,047

(22) Filed: Sep. 26, 2017

(51) Int. Cl. G06N 3/08; G06K 9/62; G06F 15/18

(52) U.S. Cl. CPC G06N 3/082; G06F 15/18; G06K 9/6256; G06N 3/084

(57) ABSTRACT

Methods and apparatus for training a neural network are disclosed. An example apparatus includes a neural network trainer to determine an amount of training error experienced in a prior training epoch of a neural network, and determine a gradient descent value based on the amount of training error. A learning rate determiner is to calculate a learning rate based on the gradient descent value and a selected number of epochs such that a training process of the neural network is completed within the selected number of epochs, the neural network trainer to update weighting parameters of the neural network based on the learning rate.

### FIELD OF THE DISCLOSURE

This disclosure relates generally to neural networks, and, more particularly, to methods and apparatus for training a neural network.

### BACKGROUND

Neural networks are useful tools that have demonstrated their value solving very complex problems regarding pattern recognition, natural language processing, automatic speech recognition, etc. Neural networks operate using neurons arranged into layers that pass data from an input layer to an output layer, applying weighting values to the data along the way. Such weighting values are determined during a training process.

### BRIEF DESCRIPTION OF THE DRAWINGS

FIG. 1 is a graph representing an example evolution of weighting values throughout a neural network training process.

FIG. 2 is a block diagram of an example computing system including a neural network processor implementing a neural network and a neural network trainer for training the neural network.

FIG. 3 is a flowchart representative of example machine-readable instructions which, when executed, cause the example computing system of FIG. 2 to utilize the neural network.

FIGS. 4A and 4B are a flowchart representative of example machine-readable instructions which, when executed, cause the example neural network trainer of FIG. 3 to train the network.

FIG. 5 is a graph representing an estimated training error through training epochs using the example approaches disclosed herein, as compared to a prior approach.

FIG. 6 is a block diagram of an example processing platform structured to execute the instructions of FIGS. 3, 4A, and/or 4B to implement the example computing system of FIG. 1.

The figures are not to scale. Wherever possible, the same reference numbers will be used throughout the drawing(s) and accompanying written description to refer to the same or like parts.

### DETAILED DESCRIPTION

Neural networks operate using neurons arranged into layers that pass data from an input layer to an output layer, applying weighting values to the data along the way. Such weighting values are determined during a training process. In some examples, training is performed at a first neural network (e.g., at a server) to determine weighting parameters, and such weighting parameters are transferred to the final neural network(s) for execution. For example, a smart-watch may implement a neural network that operates based on signals from a heart-rate monitor to identify a heartbeat. In some examples, neural network weighting parameters can be identified/trained once in a central location, and then transferred to each smart-watch for execution.

However, some applications require a training process of the neural network to be performed at the location where the neural network is to be operated. For example, centrally generated weighting parameters may not be sufficient in the context of personalization of a heart-rate monitor to a particular user's heartbeat. Unfortunately, in existing approaches, such training process is not guaranteed to happen in an environment with real time constraints. Moreover, the time consumed by a neural network to be trained is directly correlated with power consumption of the device running the training process. Thus, improving the efficiency of the training process is a key component of efficiency in the context of neural networks.

In some examples, the training process of a neural network is based on a gradient descent approach that uses iterative optimization to find a minimum (e.g., a minimum level of training error). As used herein, weighting values are expressed using Equation 1, below:

w=(w₁, . . . ,wₙ) Equation 1

In Equation 1, above, each of the weighting values w corresponds to different weights applied throughout the neural network. In Equations used herein, bold text is used to denote vectors. When training, Equation 2 is used to implement the gradient descent:

wₘ₊₁=wₘ−h̅(m)∇V Equation 2

In Equation 2, above, m represents an iteration index, ∇V represents a gradient of the mean squared error between a training data and the neural network output, h̅(m) is a learning rate, and wₘ represents the vector of weights at the m-th iteration. In examples disclosed herein, the learning rate may change (e.g., be dynamic) between iterations.

In some known approaches, the learning rate is dynamic. However, such approaches do not guarantee a maximum number of epochs required for the training process to finish. Existing approaches focus on speeding up the learning process by, for example, adapting the learning rate h̅(m) to the weights (performing larger updates for infrequent and smaller updates for frequent weights), by dividing the learning rate h̅(m) by an exponentially decaying average of squared gradients, or by maintaining an exponentially decaying average of past gradients (similar to a training momentum).

As noted above, such approaches do not reduce the uncertainty of how many epochs will be required for the training process to be completed. Indeed, in such existing approaches, the learning rate is reduced throughout the training process, resulting in the later training epochs using increasingly smaller learning rates. As a result, such approaches are not suitable for problems with hard, real-time constraints.

In examples disclosed herein, a dynamic learning rate based on error encountered in the most recent training epoch is used. In examples disclosed herein, within each epoch, the learning rate is determined using Equation 3, below:

$$\overline{h} ( m ) = h λ \frac{{( α {V}^{p} + β {V}^{q} )}^{k}}{{‖ ∇ V ‖}^{2}} \qquad Equation 3$$

In Equation 3, above, α, β, γ, h p, q, and k are design parameters that are used to ensure that training is completed within a maximum number of epochs (Mₘₐₓ). The maximum number of epochs (Mₘₐₓ) is defined using Equation 4, below:

$${M}_{m ax} = \frac{1}{{α}^{k} ( 1 - p k ) h} + \frac{1}{{β}^{k} ( qk - 1 ) h} \qquad Equation 4$$

Equation 4, above, is based on non-linear control theory which allows the training process to happen in a maximum known number of iterations. For example, in a Lyapunov stability analysis, a dynamic system can be expressed in a state space representation where the vector of states x(t)=(x₁(t), . . . , xₙ(t)) are the time dependent variables of interest and the dynamics are written in the form of a system of differential Equations (often non-linear), such as Equation 5, below:

\dot{x}=ƒ(x) Equation 5

In Equation 5, above

$$\dot{x} = \frac{dx}{dt} ,$$

and ƒ: [symbol] ⁿ→ [symbol] ⁿ is a vector field. A critical point x* is one that satisfies ƒ(x*)=0. The system is considered stable in all [symbol] ⁿ if, for any initial condition x₀, the system evolves (e.g., changes over time) and as t→∞ then x→x* for some critical point x*.

Lyapunov stability analysis states that if there exists a continuous radially unbounded function (called a Lyapunov function) V: [symbol] ⁿ→ [symbol] ₊∪{0}, such that V(x*)=0, (basically, that V(x) is a function of the state which is always positive and only zero at the critical points), and that satisfies \dot{V}<0, then the system is stable towards some x*. Using the chain rule,

$$\dot{V} = ∇ V \cdot \dot{x} = ∇ V \cdot f where ∇ V = ( \frac{\partial V}{\partial {x}_{1}} , . . . , \frac{\partial V}{\partial {x}_{n}} )$$

is the gradient and • is the dot product of vectors.

Thinking of V as the energy of the system, \dot{V}<0 means that if the energy always decreases, the system will ultimately reach a steady state (e.g., critical point). Moreover, if: \dot{V}<−(αV^{p}+βV^{q})^{k} for α, β, p, q, k>0 such that pk<1 and qk>1, then x will reach some x* in less than Tₘₐₓ per Equation 6, below:

$${T}_{ma x} = \frac{1}{{α}^{k} ( 1 - p k )} + \frac{1}{{β}^{k} ( qk - 1 )} \qquad Equation 6$$

In Equation 6, above, the parameters α, β, p, q, and k can be used to determine the total amount of iterations (e.g., epochs) required for the system to converge. Because each iteration is performed in substantially the same amount of time (e.g., within a 10% variance among epochs), the total amount of time can be approximated using the number of epochs. This type of convergence is called a fixed time stability. In the context of training a neural network, the critical point x* represents the optimal weighting parameters of the neural network.

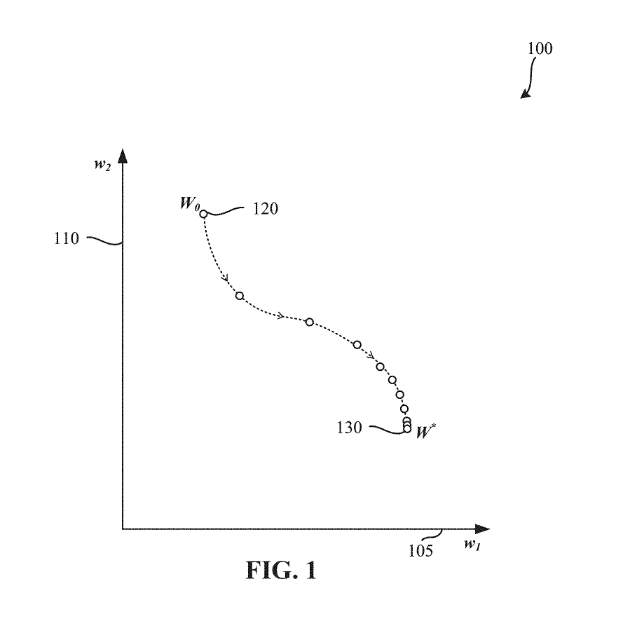

FIG. 1 is a graph 100 representing an example evolution of weighting values throughout a neural network training process. The graph 100 of FIG. 1 includes a horizontal axis 105 representing values of a first weighting value w₁, and a vertical axis 110 representing values of a second weighting value w₂. An initial training point W₀ 120 represents a beginning of a training procedure of the neural network. A final training point W* 130 represents a converged training point of the neural network. In example approaches disclosed herein, the evolution of the weights of the neural network is represented using Equation 7, below:

\dot{w}=ƒ(w) Equation 7

For the time dependent w(t), its discrete implementation will be recovered by using tₘ=hm for some small increment h. By taking the cost function as a Lyapunov function, the algorithm is designed by choosing ƒ such that \dot{V}=∇V·ƒ<0. For example, if ƒ=−∇V, then \dot{V}=−∥∇V∥²<0. In examples disclosed herein, the cost function is a mean squared error between training data and the output of the neural network. However, any other cost function may additionally or alternatively be used. As a result, training of the neural network is a stable operation, and will, at some point during training, satisfy ƒ(w*)=∇V|_{w=w*}=0.

Thus stable points of the training of the neural network are critical points of the cost function V (assuming that V does not have any maximum, those critical points can be called local minima). In order to discretize the algorithm, an approximation is shown in Equation 8:

$$\dot{w} \tilde{=} \frac{{w}_{m + 1} - {w}_{m}}{h} \\ where {w}_{m} = w ( {t}_{m} ) , then \\ \dot{w} = f ( w ) - ∇ V \to {w}_{m + 1} = {w}_{m} - h ∇ V \qquad Equation 8$$

Equation 8 represents a classical gradient descent algorithm, where h is the step size (often called “learning rate”). Example approaches utilize Equation 8, to design ƒ such that

$$f ( w ) = - γ \frac{{( α {V}^{p} + β {V}^{q} )}^{k}}{{‖ ∇ V ‖}^{2}} ∇ V$$

for some γ>1. As a result, \dot{V}=−γ(αV^{p}+βV^{q})^{k}<−(αV^{p}+βV^{q})^{k}. Thus, the weights of the neural network (w) will converge in a fixed time, less than Tₘₐₓ. By discretizing, the final algorithm is represented using Equations 9, 10, and 11, below:

$$\begin{matrix}{w}_{m + 1} = {w}_{m} - h γ \frac{{( α {V}^{p} + β {V}^{q} )}^{k}}{{‖ ∇ V ‖}^{2}} ∇ V & Equation 9 \\ \overline{h} ( m ) = h γ \frac{{( α {V}^{p} + β {V}^{q} )}^{k}}{{‖ ∇ V ‖}^{2}} & Equation 10 \\ {w}_{m + 1} = {w}_{m} - \overline{h} ( m ) ∇ V & Equation 11\end{matrix}$$

In Equation 11, above, the function h̅(m) from Equation 10 is used to represent

$$h γ \frac{{( α {V}^{p} + β {V}^{q} )}^{k}}{{‖ ∇ V ‖}^{2}}$$

from Equation 9. Equation 11 represents a gradient descent algorithm, using a variable learning rate h̅(m), that results in fixed time stability for convergence. Moreover, such an approach is not dependent upon the initial conditions of the solving process. As noted above, such an approach enables an approximation of the number of maximum iterations required for the training using Equation 12, below:

$${M}_{m ax} = \frac{{T}_{m ax}}{h} = \frac{1}{{α}^{k} ( 1 - p k ) h} + \frac{1}{{β}^{k} ( qk - 1 ) h} \qquad Equation 12$$

In Equation 12, above, Mₘₐₓ represents the maximum number of iterations to be used for training. If, for example, training were to take one hundred milliseconds per iteration, and Mₘₐₓ was set to one hundred and fifty iterations, the entire training process would take a maximum of fifteen seconds. In some examples, during the training process, the training error may be determined to be below an error threshold. In such an example, the training process may be stopped as the neural network is sufficiently trained (e.g., the neural network exhibits an amount of error below an error threshold).

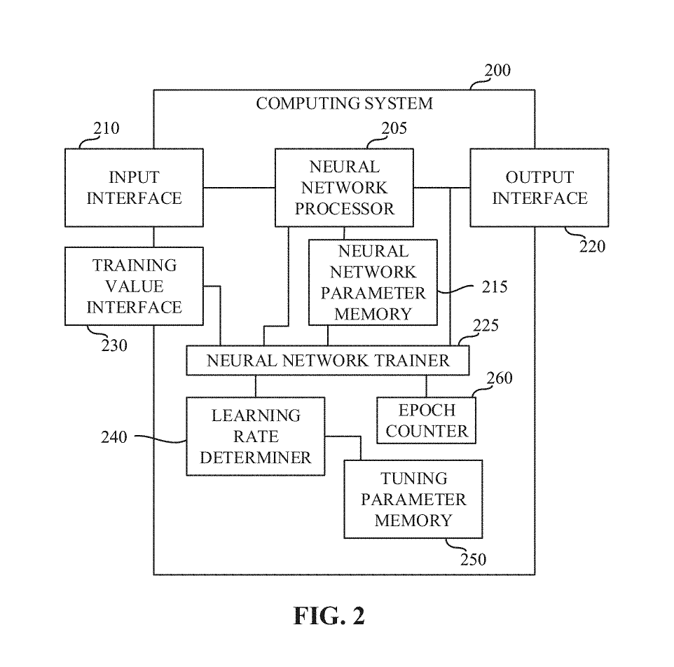

FIG. 2 is a block diagram of an example computing system 200 including a neural network processor 205 implementing a neural network and a neural network trainer 225 for training the neural network. The example computing system 200 the illustrated example of FIG. 2 includes the neural network processor 205 that receives input values via an input interface 210, processes those input values based on neural network parameters stored in a neural network parameter memory 215 to produce output values via an output interface 220. In the illustrated example of FIG. 2, the example neural network parameters stored in the neural network parameter memory 215 are trained by the neural network trainer 225 such that input training data received via a training value interface 230 results in output values based on the training data. In the illustrated example of FIG. 2, the example neural network trainer 225 interfaces with a learning rate determiner 240 to determine learning rate(s) that are to be used during the training process. The example learning rate determiner 240 interfaces with a tuning parameter memory 250 which stores tuning parameters that are used to determine the learning rates. The example neural network trainer 225 interfaces within epoch counter 260 to store a number training iterations that have occurred.

The example computing system 200 may be implemented as a component of another system such as, for example, a mobile device, a wearable device, a laptop computer, a tablet, a desktop computer, a server, etc. In some examples, the input and/or output data is received via inputs and/or outputs of the system of which the computing system 200 is a component.

The example neural network processor 205 of the illustrated example of FIG. 2 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc. In examples disclosed herein the example neural network processor 205 implements a neural network. The example neural network of the illustrated example of FIG. 2 is a feedforward neural network. However, any other past, present, and/or future neural network topology(ies) and/or architecture(s) may additionally or alternatively be used such as, for example, a convolutional neural network (CNN). In examples disclosed herein, the feedforward neural network includes two neurons in an input layer that receive input values from the input interface 210, nine neurons in a hidden layer, and five output neurons in an output layer that provide classification information to the output interface 220. However, any other neural network configuration having any number of hidden layers and/or any number of neurons per layer may additionally or alternatively be used.

The example input interface 210 of the illustrated example of FIG. 2 receives input data that is to be processed by the example neural network processor 205. In examples disclosed herein, the example input interface 210 receives data from one or more sensors. However, the input data may be received in any fashion such as, for example, from an external device (e.g., via a wired and/or wireless communication channel). In some examples, multiple different types of inputs may be received.

The example neural network parameter memory 215 of the illustrated example of FIG. 2 is implemented by any memory, storage device and/or storage disc for storing data such as, for example, flash memory, magnetic media, optical media, etc. Furthermore, the data stored in the example neural network parameter memory 215 may be in any data format such as, for example, binary data, comma delimited data, tab delimited data, structured query language (SQL) structures, etc. While in the illustrated example the neural network parameter memory 215 is illustrated as a single element, the neural network parameter memory 215 and/or any other data storage elements described herein may be implemented by any number and/or type(s) of memories. In the illustrated example of FIG. 2, the example neural network parameter memory 215 stores neural network weighting parameters that are used by the neural network processor 205 to process inputs for generation of one or more outputs.

The example output interface 220 of the illustrated example of FIG. 2 outputs results of the processing performed by the neural network processor 205. In examples disclosed herein, the example output interface outputs information that classifies the inputs received via the input interface 210 (e.g., as determined by the neural network processor 205.). In examples disclosed herein, the example output interface 220 displays the output values. However, in some examples, the output interface 220 may provide the output values to another system (e.g., another circuit, an external system). In some examples, the output interface 220 may cause the output values to be stored in a memory.

The example neural network trainer 225 of the illustrated example of FIG. 2 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. In some examples, the example neural network trainer 225 is implemented using a same logic circuit as the example neural network processor 205.

The example neural network trainer 225 determines tuning parameters based on a maximum number of desired training epochs. As noted above, controlling the number of training epochs enables control of how long the training process will take, thereby ensuring the amount of processing power and, energy consumed during the training process is reduced. In examples disclosed herein, each of α, β, γ, h p, q, and k are tuning parameters that are used to ensure that training is completed within a maximum number of epochs (Mₘₐₓ). The tuning parameters α, β, p, q, and k are selected such that they are positive, such that pk is less than one, and such that qk is greater than one. In examples disclosed herein, the tuning parameters are set to: α=0.3; β=0.3; γ=1.001; h=0.1; p=0.2; q=2; and k=0.7. Such tuning parameters result in the maximum number of epochs being one hundred and fifty epochs. However, any other tuning parameters may be used. In examples disclosed herein, the example neural network trainer 225 implements a non-linear solver with constraints (e.g., the tuning parameters α, β, p, q, and k are selected such that they are positive, such that pk is less than one, and such that qk is greater than one, etc.). However, in some examples, the tuning parameters may be pre-selected and/or may be stored in a memory to facilitate selection of the tuning parameters. Table 1, below shows example tuning parameters and corresponding Mₘₐₓh values.

TABLE 1

| α | β | p | q | k | Mₘₐₓ h |
|---|---|---|---|---|---|
| 4 | 4 | 0.2 | 8 | 0.35 | 1.003890 |
| 1 | 1 | 0.5 | 8 | 0.272 | 2.007748 |
| 0.9 | 0.5 | 0.5 | 8 | 0.202 | 3.003632 |
| 0.15 | 0.13 | 0.5 | 8 | 0.2055 | 4.007445 |
| 0.173 | 0.28 | 0.9 | 8 | 0.5 | 5.001277 |
| 0.105 | 0.7 | 0.9 | 8 | 0.5 | 6.009440 |
| 0.1099 | 0.8 | 0.9 | 8 | 0.55 | 7.003046 |
| 0.101 | 5 | 0.9 | 9 | 0.58 | 8.001155 |
| 0.098 | 0.9 | 0.9 | 9 | 0.6 | 9.002153 |
| 0.12 | 0.31 | 0.9 | 9 | 0.65 | 10.00202 |

In Table 1, above, the value Mₘₐₓh is chosen to be approx. 1, 2, 3, . . . , 9, 10, and the values of the tuning parameters are calculated for those selected values of Mₘₐₓh. If, for example, the desired number of epochs was 500, Mₘₐₓh can be selected to be 5.00127 (with parameters α=0.173; β=0.28; p=0.9; q=8; and k=0.5), and h can be set to 0.010003, to result in an Mₘₐₓ of approximately 500. Alternatively, Mₘₐₓh could be set to 4.007445 (see line 4 of Table 1, above), with h=0.0080149, also resulting in an Mₘₐₓ of approximately 500. In some examples, the selection of the tuning parameters is performed in an offline manner. Once selected, the tuning parameters are stored in the tuning parameter memory 250 such that they can be used by the example learning rate determiner 240.

The example learning rate determiner 240 determines and provides a learning rate to the neural network trainer 225. Using the example learning rate determined by the learning rate determiner 240, the example neural network trainer 225 trains the neural network and updates the neural network parameters stored in the example neural network parameter memory 215. In examples disclosed herein, the training is performed based on the learning rate, which may change from one epoch to the next based on the error encountered in the prior epoch. During training, the example neural network trainer 225 calculates a gradient descent value. In examples disclosed herein, calculation of the gradient descent value is based on training error identified in the prior training epoch. In an initial epoch, the example error is identified as a nonzero value such as, for example, one. However, any other initial error value may additionally or alternatively be used. In example approaches disclosed herein, because of the utilization of the dynamic learning rate defined in, for example, Equation 10, the training process is not dependent upon the initial neural network parameters and/or error associated with those initial neural network parameters. That is, the training time using the example approaches disclosed herein remains the same for any initial neural network parameters.

After performing the training, the example neural network trainer 225 compares expected outputs received via the training value interface 230 to outputs produced by the example neural network processor 205 to determine an amount of training error. In examples disclosed herein, errors are identified when the input data does not result in an expected output. That is, error is represented as a number of incorrect outputs given inputs with expected outputs. However, any other approach to representing error may additionally or alternatively be used such as, for example, a percentage of input data points that resulted in an error.

The example neural network trainer 225 determines whether the training error is less than a training error threshold. If the training error is less than the training error threshold, then the neural network is been trained such that it results in a sufficiently low amount of error, and no further training is needed. In examples disclosed herein, the training error threshold is ten errors. However, any other threshold may additionally or alternatively be used. Moreover, the example threshold may be evaluated in terms of a percentage of training inputs that resulted in an error (e.g., no more than 0.1% error). If the training error is not less than the three training error threshold, the example neural network trainer 225 determines a gradient descent value based on the determined error value of the prior epoch.

The example training value interface 230 of the illustrated example of FIG. 2 receives training data that includes example inputs (corresponding to the input data expected to be received via the example input interface 210), as well as expected output data. In examples disclosed herein, the example training value interface 230 provides the training data to the neural network trainer to enable the neural network trainer 225 to determine an amount of training error.

The example learning rate determiner 240 of the illustrated example of FIG. 2 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), DSP(s), etc. In some examples, the example learning rate determiner 240 is implemented using a same logic circuit as the example neural network processor 205 and/or the example neural network trainer 225.

The example learning rate determiner 240 determines the learning rate to be used for each training epoch for the neural network trainer 225. In examples disclosed herein, the calculation of the learning rate by the example learning rate determiner is performed using the tuning parameters stored in the tuning parameter memory 250, as well as the gradient descent value calculated by the example neural network trainer 225.

In some examples, the example learning rate determiner 240 determines whether the calculated learning rate is greater than a learning rate threshold. If the example learning rate is greater than the learning rate threshold, the example learning rate determiner 240 sets the learning rate to the threshold learning rate. Setting the learning rate to the threshold learning rate ensures that the learning rate is not too large, which could result in training instability.

The example tuning parameter memory 250 of the illustrated example of FIG. 2 is implemented by any memory, storage device and/or storage disc for storing data such as, for example, flash memory, magnetic media, optical media, etc. Furthermore, the data stored in the example tuning parameter memory 250 may be in any data format such as, for example, binary data, comma delimited data, tab delimited data, structured query language (SQL) structures, etc. While in the illustrated example the tuning parameter memory 250 is illustrated as a single element, the tuning parameter memory 250 and/or any other data storage elements described herein may be implemented by any number and/or type(s) of memories. In the illustrated example of FIG. 2, the example tuning parameter memory 250 stores tuning parameters that are used by the example learning rate determiner 240 to determine the learning rate such as, for example, α, β, γ, h p, q, and k (see Equations 3, 4, 6, 9, 10, 12, 13, and 14). In examples disclosed herein, the tuning parameters are determined by the neural network trainer 225 and stored in the tuning parameter memory 250 as a part of the neural network training process. However, the tuning parameters may stored in the tuning parameter memory 250 at any other time (e.g., at a time other than as part of the neural network training process) such as, for example, at a time of manufacture of the computing system 200.

The example epoch counter 260 of the illustrated example of FIG. 2 is implemented by any memory, storage device and/or storage disc for storing data such as, for example, flash memory, magnetic media, optical media, etc. Furthermore, the data stored in the example epoch counter 260 may be in any data format such as, for example, binary data, comma delimited data, tab delimited data, structured query language (SQL) structures, etc. While in the illustrated example the epoch counter 260 is illustrated as a single element, the epoch counter 260 and/or any other data storage elements described herein may be implemented by any number and/or type(s) of memories. In the illustrated example of FIG. 2, the example epoch counter 260 stores a number of training epochs that have elapsed. Storing the number of epochs that have elapsed enables the example neural network trainer 225 to exit training when the epoch counter 260 meets or exceeds a maximum number of desired epochs.

While an example manner of implementing the example computing system 205 is illustrated in FIG. 2, one or more of the elements, processes and/or devices illustrated in FIG. 2 may be combined, divided, re-arranged, omitted, eliminated and/or implemented in any other way. Further, the example neural network processor 205 the example input interface 210, the example neural network parameter memory 215, the example output interface 220, the example neural network trainer 225, the example training value interface 230, the example learning rate determiner 240, the example tuning parameter memory 250, the example epoch counter 260, and/or, more generally, the computing system 200 of FIG. 2 may be implemented by hardware, software, firmware and/or any combination of hardware, software and/or firmware. Thus, for example, any of the example neural network processor 205 the example input interface 210, the example neural network parameter memory 215, the example output interface 220, the example neural network trainer 225, the example training value interface 230, the example learning rate determiner 240, the example tuning parameter memory 250, the example epoch counter 260, and/or, more generally, the computing system 200 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example neural network processor 205 the example input interface 210, the example neural network parameter memory 215, the example output interface 220, the example neural network trainer 225, the example training value interface 230, the example learning rate determiner 240, the example tuning parameter memory 250, the example epoch counter 260, and/or, more generally, the computing system 200 of FIG. 2 is/are hereby expressly defined to include a non-transitory computer readable storage device or storage disk such as a memory, a digital versatile disk (DVD), a compact disk (CD), a Blu-ray disk, etc. including the software and/or firmware. Further still, the example computing system 205 of FIG. 2 may include one or more elements, processes and/or devices in addition to, or instead of, those illustrated in FIG. 2, and/or may include more than one of any or all of the illustrated elements, processes, and devices.

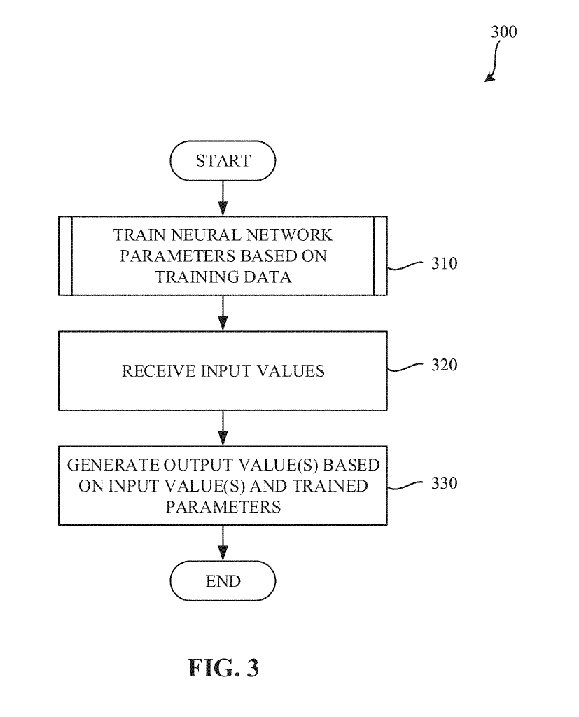

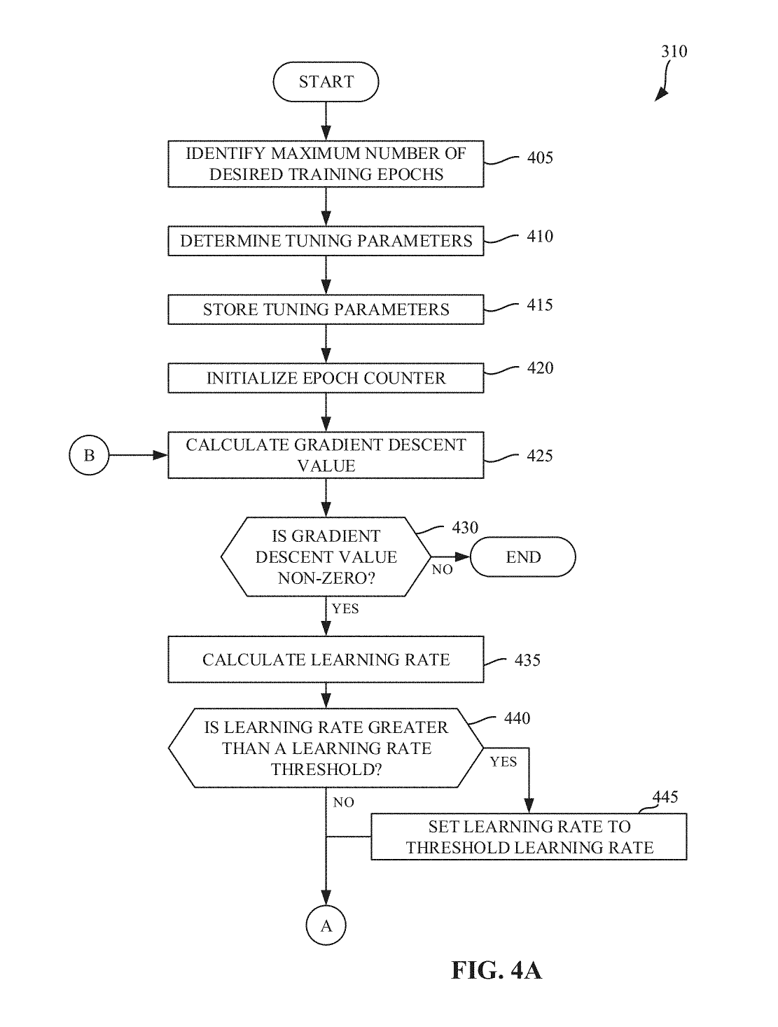

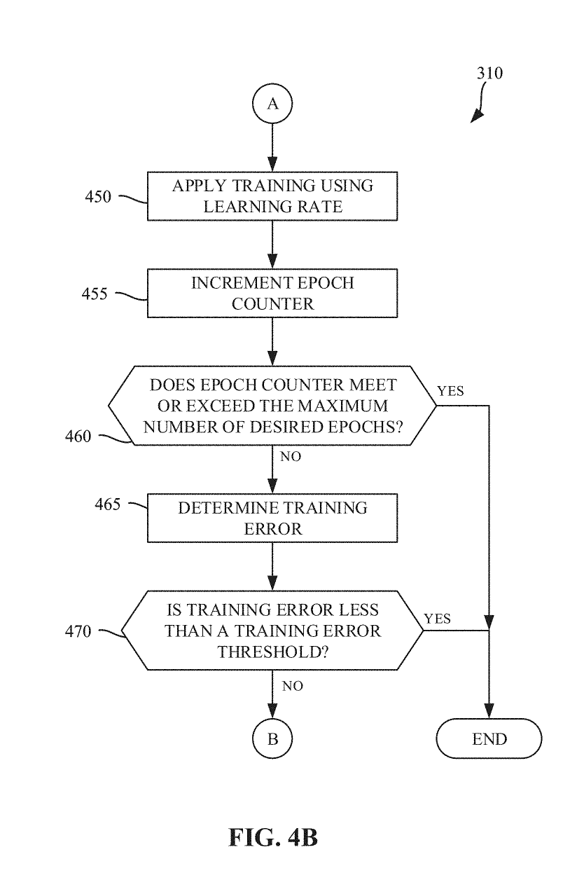

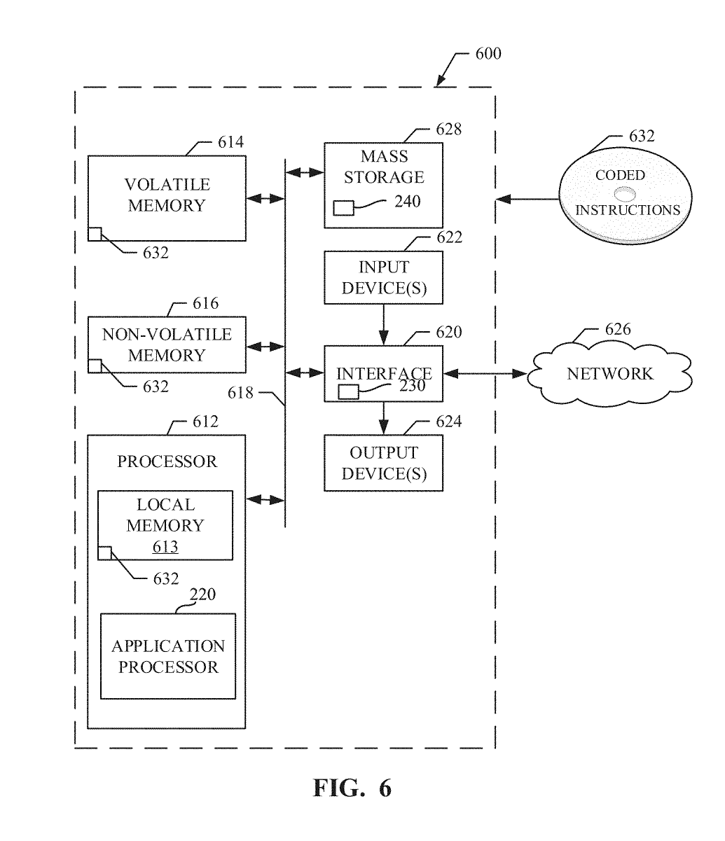

Flowcharts representative of example machine readable instructions for implementing the example computing system 205 of FIG. 2 are shown in FIGS. 3, 4A, and/or 4B. In these example(s), the machine readable instructions comprise a program for execution by a processor such as the processor 612 shown in the example processor platform 600 discussed below in connection with FIG. 6. The program may be embodied in software stored on a non-transitory computer readable storage medium such as a CD-ROM, a floppy disk, a hard drive, a digital versatile disk (DVD), a Blu-ray disk, or a memory associated with the processor 612, but the entire program and/or parts thereof could alternatively be executed by a device other than the processor 612 and/or embodied in firmware or dedicated hardware. Further, although the example program is described with reference to the flowchart(s) illustrated in FIGS. 3, 4A, and/or 4B, many other methods of implementing the example computing system 205 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example processes of FIGS. 3, 4A, and/or 4B may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

FIG. 3 is a flowchart representative of example machine-readable instructions 300 which, when executed, cause the example computing system 205 of FIG. 2 to utilize the neural network. The example process 300 of FIG. 3 begins when the example neural network trainer 225 trains (e.g., sets, updates, adjusts, etc.) neural network parameters stored in neural network parameter memory 215 based on training data received via the training value interface 230. (Block 310). In examples disclosed herein, the training process is performed locally at the computing system 200. However, the training process may be performed in any other location such as, for example, a server, a personal computer, a cloud computing system, etc. An example approach for training the neural network parameters is shown in FIGS. 4A and 4B, below.

Once training is complete, the example neural network processor 205 receives input values via the input interface 210. (Block 320). Using the neural network parameters stored in the neural network parameter memory 215, the example neural network processor 205 analyzes the input values to generate output values. (Block 330). The example process 300 the illustrated example of FIG. 3 then terminates. In some examples, upon subsequent receipt of input data, training (and/or re-training) of the neural network is not subsequently performed. That is, the example neural network processor 205 may operate based on input data received via the input interface 210 and neural network parameters stored in the neural network parameter memory 215 to produce output values via the output interface 220.

FIGS. 4A and 4B are a flowchart representative of example machine-readable instructions 310 which, when executed, cause the example neural network trainer 225 of FIG. 3 to train the network. The example process 310 of the illustrated example of FIG. 4A begins when the example neural network trainer 225 identifies a maximum number of desired training epochs. (Block 405). In examples disclosed herein, each epoch consumes approximately 100 milliseconds of processing time. However, any other amount of processing time may be consumed during each epoch. In examples disclosed herein, the maximum number of desired training epochs is one hundred and fifty, resulting in a maximum training time of approximately fifteen seconds. However, any other number may be used for the maximum number of desired training epochs, based on the desired amount of time required to train the neural network.

The example neural network trainer 225 determines tuning parameters based on the maximum number of desired epochs. (Block 410). In examples disclosed herein, the tuning parameters are derived using Equation 13, below:

$${M}_{m ax} = \frac{1}{{α}^{k} ( 1 - p k ) h} + \frac{1}{{β}^{k} ( qk - 1 ) h} \qquad Equation 13$$

In Equation 13, each of α, β, γ, h p, q, and k are tuning parameters that are used to ensure that training is completed within a maximum number of epochs (Mₘₐₓ). The tuning parameters α, β, p, q, and k are selected such that they are positive, such that pk is less than one, and such that qk is greater than one. In examples disclosed herein, the tuning parameters are set to: α=0.3; β=0.3; γ=1.001; h=0.1; p=0.2; q=2; and k=0.7. Such tuning parameters result in the maximum number of epochs being one hundred and fifty epochs. However, any other tuning parameters may be used. The example neural network trainer 225 stores the tuning parameters in the tuning parameter memory 250. (Block 415).

The example neural network trainer 225 then initializes the epoch counter 260. (Block 420). In examples disclosed herein, the epoch counter 260 is initialized to zero. However, the example epoch counter may be initialized any other value.

The example neural network trainer 225 then calculates a gradient descent value. (Block 425). In the illustrated example of FIG. 4A, calculation of the gradient descent value is based on training error identified in the prior training epoch (see Block 465, below). In an initial instance of the execution of block 425, the example error is identified as a nonzero value such as, for example, one. However, any other initial error value may additionally or alternatively be used.

The example neural network trainer 225 determines whether the calculated gradient descent value is nonzero. (Block 430). If the gradient descent value is equal to zero (e.g., Block 430 returns a result of NO), no additional training is required, as the neural network has reached a point of stability.

If the gradient descent value is nonzero (e.g., block 430 returns a result of YES), the example learning rate determiner 240 determines the learning rate to be used for the epoch. (Block 435). In examples disclosed herein, the calculation of the learning rate by the example learning rate determiner is performed using the tuning parameters stored in the tuning parameter memory 250, as well as the gradient descent value calculated by the example neural network trainer 225. In particular, the example learning rate determiner 240 calculates the learning rate using Equation 14, below:

$$\overline{h} ( m ) = h γ \frac{ {( α {V}^{p} + β {V}^{q} )}^{k}}{{‖ ∇ V ‖}^{2}} \qquad Equation 14$$

In Equation 14, α, β, γ, h p, q, and k represent the example tuning parameters stored in the tuning parameter memory 250, ∥∇V∥² represents the gradient descent value calculated by the example neural network trainer 225, and V represents training error encountered in the prior epoch.

The example learning rate determiner 240 determines whether the calculated learning rate is greater than a learning rate threshold. (Block 440). If the example learning rate is greater than the learning rate threshold (e.g., Block 440 returns a result of NO), the example learning rate determiner 240 sets the learning rate to the threshold learning rate. (Block 445). Setting the learning rate to the threshold learning rate ensures that the learning rate is not too large, which could result in training instability. Upon setting the learning rate to the threshold learning rate (Block 445), or the learning rate determiner 240 determining that the learning rate is not greater than the learning rate threshold (e.g., block 440 returns result of NO), control proceeds to block 450 of FIG. 4B.

Using the example learning rate determined by the learning rate determiner 240, the example neural network trainer 225 trains the neural network and updates the neural network parameters stored in the example neural network parameter memory 215. In examples disclosed herein, the training is performed based on the learning rate, which may change from one epoch to the next based on the error encountered in the prior epoch. The example neural network trainer 225 increments the epoch counter 260. (Block 455).

The example neural network trainer 225 determines whether the value stored in the epoch counter 260 meets or exceeds the maximum number of desired epochs. (Block 460). Upon reaching the maximum number of desired epochs, the neural network should be sufficiently trained and have reached stability. Thus, if the epoch counter 260 meets or exceeds the maximum number of desired epochs (e.g., block 460 returns a result of YES), the example training process terminates. If the value of the example epoch counter 260 does not meet or exceed the maximum number of desired epochs (e.g., block 460 returns a result of NO), the example neural network trainer 225 determines current training error by causing the neural network processor 205 to apply the newly trained neural network parameters stored in the neural network parameter memory 215 using training data received via the training value interface 230. (Block 465). The example neural network trainer 225 compares expected outputs received via the training value interface 230 to outputs produced by the example neural network processor 205 to determine an amount of training error. In examples disclosed herein, errors are identified when the input data does not result in an expected output. That is, error is represented as a number of incorrect outputs given inputs with expected outputs. However, any other approach to representing error may additionally or alternatively be used such as, for example, a percentage of input data points that resulted in an error.

The example neural network trainer 225 then determines whether the training error is less than training error threshold. (Block 470). If the training error is less than the training error threshold (e.g., block 470 returns a result of YES), then the neural network is been trained such that it results in a sufficiently low amount of error, and the example process 310 terminates. In examples disclosed herein, the training error threshold is set to ten errors. However, any other threshold may additionally or alternatively be used. Moreover, the example threshold may be evaluated in terms of a percentage of training inputs that resulted in an error. If the training error is not less than the three training error threshold (e.g., block 470 returns a result of NO), control proceeds to block 425 of FIG. 4A, where the example neural network trainer 225 determines a gradient descent value based on the determined error value of the prior epoch. (Block 425).

The example process of blocks 425 through blocks 470 is then repeated until the gradient descent value reaches zero (e.g., block 430 returns a result of NO), until the training error is reduced to below the training error threshold (e.g., block 470 returns a result of YES), or until the number of epochs meets or exceeds the maximum number of desired epochs (e.g., block 460 returns a result of YES). The example process 310 of the illustrated example of FIGS. 4A and 4B may then be repeated to retrain the neural network parameters stored in the example neural network parameter memory 215. Such retraining may be performed periodically (e.g., once a day, once a week, etc.), and/or a-periodically (e.g., on demand, etc.).

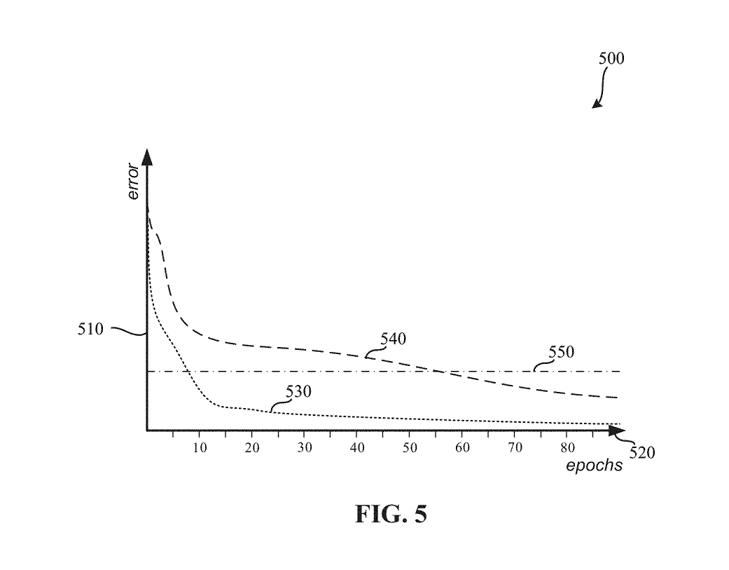

FIG. 5 is a graph representing an estimated training error through training epochs using the example approaches disclosed herein, as compared to a prior approach. The example graph 500 of FIG. 5 includes a vertical axis 510 representing an amount of error, and a horizontal axis 520 representing the epoch in which the error was encountered. In the illustrated example of FIG. 5, the horizontal axis 520 represents eighty epochs (e.g., training iterations). The example graph 500 the illustrated example of FIG. 5 includes a first curve 530 that represents error values throughout training epoch encountered using example approaches disclosed herein. A second example curve 540 represents error values throughout training epochs encountered using a prior approach (e.g., an approach that does not update the learning rate based on error encountered in the prior epoch). The example graph 500 includes a threshold line 550 representing the training error threshold. In the illustrated example of FIG. 5, training could have been terminated after approximately seven epochs using the example approaches disclosed herein (e.g., the intersection of the first curve 530 and the threshold line 550), whereas prior approaches would have taken approximately fifty five epochs to reach the same level of training error (e.g., the intersection of the second curve 540 and the threshold line 550).

FIG. 6 is a block diagram of an example processor platform 600 capable of executing the instructions of FIGS. 3, 4A, 4B to implement the computing system 205 of FIG. 2. The processor platform 600 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 600 of the illustrated example includes a processor 612. The processor 612 of the illustrated example is hardware. For example, the processor 612 can be implemented by one or more integrated circuits, logic circuits, microprocessors or controllers from any desired family or manufacturer. The hardware processor may be a semiconductor based (e.g., silicon based) device. In this example, the processor 612 implements the example application processor 220.

The processor 612 of the illustrated example includes a local memory 613 (e.g., a cache). The processor 612 of the illustrated example is in communication with a main memory including a volatile memory 614 and a non-volatile memory 616 via a bus 618. In some examples, the bus 618 includes multiple different buses. The example bus 618 implements the example system management bus 275 and/or the example data bus 285. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes an interface circuit 620. The interface circuit 620 may be implemented by any type of interface standard, such as an Ethernet interface, a universal serial bus (USB), and/or a PCI express interface.

In the illustrated example, one or more input devices 622 are connected to the interface circuit 620. The input device(s) 622 permit(s) a user to enter data and/or commands into the processor 612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 624 are also connected to the interface circuit 620 of the illustrated example. The output devices 624 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 620 of the illustrated example, thus, typically includes a graphics driver card, a graphics driver chip and/or a graphics driver processor.

The interface circuit 620 of the illustrated example also includes a communication device such as a transmitter, a receiver, a transceiver, a modem and/or network interface card to facilitate exchange of data with external machines (e.g., computing devices of any kind) via a network 626 (e.g., an Ethernet connection, a digital subscriber line (DSL), a telephone line, coaxial cable, a cellular telephone system, etc.). The example interface 620 implements the example programmable logic device 230.

The processor platform 600 of the illustrated example also includes one or more mass storage devices 628 for storing software and/or data. Examples of such mass storage devices 628 include floppy disk drives, hard drive disks, compact disk drives, Blu-ray disk drives, RAID systems, and digital versatile disk (DVD) drives.

The coded instructions 632 of FIG. 4 may be stored in the mass storage device 628, in the volatile memory 614, in the non-volatile memory 616, and/or on a removable tangible computer readable storage medium such as a CD or DVD.

From the foregoing, it will be appreciated that example methods, apparatus, and articles of manufacture have been disclosed that enable an approximation of a number of iterations required for training a neural network. Controlling the number of training epochs enables control of how long the training process will take, thereby ensuring the amount of processing power and/or energy consumed during the training process is reduced. Because of such a reduction in processing power utilized and/or energy consumed during the training process, such processing can be completed by devices where such processing would not have ordinarily occurred such as, for example, mobile device, wearable devices, etc. Such an approach enables training to be completed by such end user devices in an “online” setting (e.g., while the device is operating), without causing interruption to the use of the device. Moreover, because of the utilization of the dynamic learning rate defined in, for example, Equation 10, the training process is not dependent upon the initial neural network parameters and/or error associated with those initial neural network parameters.

Example 1 includes an apparatus to train a neural network, the apparatus comprising a neural network trainer to determine an amount of training error experienced in a prior training epoch of a neural network, and determine a gradient descent value based on the amount of training error; and a learning rate determiner to calculate a learning rate based on the gradient descent value and a selected number of epochs such that a training process of the neural network is completed within the selected number of epochs, the neural network trainer to update weighting parameters of the neural network based on the learning rate.

Example 2 includes the apparatus of example 1, wherein the neural network trainer is further to determine tuning parameters such that a training process is completed within a maximum number of epochs.

Example 3 includes the apparatus of example 2, further including a tuning parameter memory to store the tuning parameters.

Example 4 includes the apparatus of example 1, further including an epoch counter to store a number of epochs that have elapsed during the training process, and the neural network trainer is to, in response to determining that the number of epochs that have elapsed meets or exceeds the maximum number of epochs, terminate the training process.

Example 5 includes the apparatus of example 1, wherein the neural network trainer is further to, in response to determining that the amount of training error is less than a training error threshold, terminate the training process.

Example 6 includes the apparatus of any one of examples 1 through 5, wherein the learning rate is a first learning rate, and the learning rate determiner is to determine a second learning rate corresponding to a subsequent epoch, the second learning rate different from the first learning rate.

Example 7 includes the apparatus of any one of examples 1 through 6, wherein the learning rate determiner is to determine whether the learning rate is greater than a learning rate threshold, and, in response to determining that the learning rate is greater than the learning rate threshold, set the learning rate to the learning rate threshold.

Example 8 includes the apparatus of any one of examples 1 through 7, further including a neural network processor to process an input to generate an output based on the weighting parameters.

Example 9 includes at least one non-transitory computer-readable storage medium comprising instructions which, when executed, cause a processor to at least determine an amount of training error experienced in a prior training epoch; determine a gradient descent value based on the amount of training error; calculate a learning rate based on the gradient descent value and a selected number of epochs such that a neural network training process is completed within the selected number of epochs; and update weighting parameters of the neural network based on the learning rate.

Example 10 includes the at least one non-transitory computer-readable storage medium of example 9, wherein the instructions, when executed, further cause the machine to calculate the learning rate based on tuning parameters selected such that the training process is completed within the selected number of epochs.

Example 11 includes the at least one non-transitory computer-readable storage medium of example 9, wherein the instructions, when executed, further cause the machine to count a number of epochs that have elapsed during the training process; and in response to a determination that the number of epochs that have elapsed meets or exceeds the selected number of epochs, terminate the training process.

Example 12 includes the at least one non-transitory computer-readable storage medium of example 9, wherein the instructions, when executed, further cause the machine to determine an amount of training error using the updated weighting parameters; and in response to a determination that the amount of training error is less than a training error threshold, terminate the training process.

Example 13 includes the at least one non-transitory computer-readable storage medium of any one of examples 9 through 12, wherein the learning rate is a first learning rate, and the instructions, when executed, further cause the machine to determine a second learning rate corresponding to a subsequent epoch, the second learning rate different from the first learning rate.

Example 14 includes the at least one non-transitory computer-readable storage medium of example 9, wherein the instructions, when executed, further cause the machine to determine whether the learning rate is greater than a learning rate threshold; and in response to a determination that the learning rate is greater than the learning rate threshold, set the learning rate to the learning rate threshold.

Example 15 includes a method of training a neural network, the method comprising determining an amount of training error experienced in a prior training epoch; determining a gradient descent value based on the amount of training error; calculating, by executing an instruction with a processor, a learning rate based on the gradient descent value, the amount of training error, and tuning parameters, the tuning parameters selected such that a training process is completed within a maximum number of epochs; and updating weighting parameters of the neural network based on the learning rate.

Example 16 includes the method of example 15, further including counting a number of epochs that have elapsed during the training process; and in response to determining that the number of epochs that have elapsed meets or exceeds the maximum number of epochs, terminating the training process.

Example 17 includes the method of example 15, further including determining an amount of training error using the updated weighting parameters; and in response to determining that the amount of training error is less than a training error threshold, terminating the training process.

Example 18 includes the method of any one of examples 15 through 17, wherein the learning rate is a first learning rate, and further including determining a second learning rate corresponding to a subsequent epoch, the second learning rate different from the first learning rate.

Example 19 includes the method of example 15, further including determining whether the learning rate is greater than a learning rate threshold; and in response to determining that the learning rate is greater than the learning rate threshold, setting the learning rate to the learning rate threshold.

Example 20 includes the method of any one of examples 15 through 19, wherein the learning rate is determined as a first tuning parameter times a sum of a second tuning parameter times the training error to the power of a third tuning parameter and a fourth tuning parameter times the training error to the power of a fifth tuning parameter, to the power of a sixth tuning parameter, divided by the gradient descent value.

Example 21 includes the method of example 20, wherein the first tuning parameter, the second tuning parameter, the third tuning parameter, the fourth tuning parameter, the fifth tuning parameter, and the sixth tuning parameter are positive values.

Example 22 includes an apparatus to train a neural network, the apparatus comprising first means determining an amount of training error experienced in a prior training epoch of a neural network; second means for determining a gradient descent value based on the amount of training error; means for calculating a learning rate based on the gradient descent value and a selected number of epochs such that a training process of the neural network is completed within the selected number of epochs; and means for updating weighting parameters of the neural network based on the learning rate.

Example 23. the apparatus of example 22, further including means for selecting tuning parameters such that a training process is completed within a maximum number of epochs.

Example 24 includes the apparatus of example 23, further including means for storing the tuning parameters.

Example 25 includes the apparatus of example 22, further including means for storing a number of epochs that have elapsed during the training process; and means for terminating the training process in response to a determination that the number of epochs that have elapsed meets or exceeds the maximum number of epochs.

Example 26 includes the apparatus of example 22, further including means for terminating the training process in response to determining that the amount of training error is less than a training error threshold.

Example 27 includes the apparatus of example 22, wherein the learning rate is a first learning rate, and the means for determining is to determine a second learning rate corresponding to a subsequent epoch, the second learning rate different from the first learning rate.

Example 28 includes the apparatus of any one of examples 23 through 27, wherein the means for determining is to determine whether the learning rate is greater than a learning rate threshold, and, in response to determining that the learning rate is greater than the learning rate threshold, set the learning rate to the learning rate threshold.

Example 29 includes the apparatus of any one of examples 23 through 28, further including means for processing an input to generate an output based on the weighting parameters.

Although certain example methods, apparatus, and articles of manufacture have been disclosed herein, the scope of coverage of this patent is not limited thereto. On the contrary, this patent covers all methods, apparatus, and articles of manufacture fairly falling within the scope of the claims of this patent.

What is claimed is:

1. An apparatus to train a neural network, the apparatus comprising:
a neural network trainer to determine an amount of training error experienced in a prior training epoch of a neural network, and determine a gradient descent value based on the amount of training error; and
a learning rate determiner to calculate a learning rate based on the gradient descent value and a selected number of epochs such that a training process of the neural network is completed within the selected number of epochs, the neural network trainer to update weighting parameters of the neural network based on the learning rate.

2. The apparatus of claim 1, wherein the neural network trainer is further to determine tuning parameters such that a training process is completed within a maximum number of epochs.

3. The apparatus of claim 2, further including a tuning parameter memory to store the tuning parameters.

4. The apparatus of claim 1, further including an epoch counter to store a number of epochs that have elapsed during the training process, and the neural network trainer is to, in response to determining that the number of epochs that have elapsed meets or exceeds the maximum number of epochs, terminate the training process.

5. The apparatus of claim 1, wherein the neural network trainer is further to, in response to determining that the amount of training error is less than a training error threshold, terminate the training process.

6. The apparatus of claim 1, wherein the learning rate is a first learning rate, and the learning rate determiner is to determine a second learning rate corresponding to a subsequent epoch, the second learning rate different from the first learning rate.

7. The apparatus of claim 1, wherein the learning rate determiner is to determine whether the learning rate is greater than a learning rate threshold, and, in response to determining that the learning rate is greater than the learning rate threshold, set the learning rate to the learning rate threshold.

8. The apparatus of claim 1, further including a neural network processor to process an input to generate an output based on the weighting parameters.

9. At least one non-transitory computer-readable storage medium comprising instructions which, when executed, cause a processor to at least:
determine an amount of training error experienced in a prior training epoch;
determine a gradient descent value based on the amount of training error;
calculate a learning rate based on the gradient descent value and a selected number of epochs such that a neural network training process is completed within the selected number of epochs; and
update weighting parameters of the neural network based on the learning rate.

10. The at least one non-transitory computer-readable storage medium of claim 9, wherein the instructions, when executed, further cause the machine to calculate the learning rate based on tuning parameters selected such that the training process is completed within the selected number of epochs.

11. The at least one non-transitory computer-readable storage medium of claim 9, wherein the instructions, when executed, further cause the machine to:
count a number of epochs that have elapsed during the training process; and
in response to a determination that the number of epochs that have elapsed meets or exceeds the selected number of epochs, terminate the training process.

12. The at least one non-transitory computer-readable storage medium of claim 9, wherein the instructions, when executed, further cause the machine to:
determine an amount of training error using the updated weighting parameters; and
in response to a determination that the amount of training error is less than a training error threshold, terminate the training process.

13. The at least one non-transitory computer-readable storage medium of claim 9, wherein the learning rate is a first learning rate, and the instructions, when executed, further cause the machine to determine a second learning rate corresponding to a subsequent epoch, the second learning rate different from the first learning rate.

14. The at least one non-transitory computer-readable storage medium of claim 9, wherein the instructions, when executed, further cause the machine to:
determine whether the learning rate is greater than a learning rate threshold; and
in response to a determination that the learning rate is greater than the learning rate threshold, set the learning rate to the learning rate threshold.

15. A method of training a neural network, the method comprising:
determining an amount of training error experienced in a prior training epoch;
determining a gradient descent value based on the amount of training error;
calculating, by executing an instruction with a processor, a learning rate based on the gradient descent value, the amount of training error, and tuning parameters, the tuning parameters selected such that a training process is completed within a maximum number of epochs; and
updating weighting parameters of the neural network based on the learning rate.

16. The method of claim 15, further including:
counting a number of epochs that have elapsed during the training process; and
in response to determining that the number of epochs that have elapsed meets or exceeds the maximum number of epochs, terminating the training process.

17. The method of claim 15, further including:
determining an amount of training error using the updated weighting parameters; and
in response to determining that the amount of training error is less than a training error threshold, terminating the training process.

18. The method of claim 15, wherein the learning rate is a first learning rate, and further including determining a second learning rate corresponding to a subsequent epoch, the second learning rate different from the first learning rate.

19. The method of claim 15, further including:
determining whether the learning rate is greater than a learning rate threshold; and
in response to determining that the learning rate is greater than the learning rate threshold, setting the learning rate to the learning rate threshold.

20. The method of claim 15, wherein the learning rate is determined as a first tuning parameter times a sum of a second tuning parameter times the training error to the power of a third tuning parameter and a fourth tuning parameter times the training error to the power of a fifth tuning parameter, to the power of a sixth tuning parameter, divided by the gradient descent value.
